(19) United States
(12) Patent Application Publication
(10) Pub. No.: US 2010/0328300 A1
(43) Pub. Date: Dec. 30, 2010

(54) PLASMA DISPLAY PANEL DRIVING DEVICE

(75) Inventors: Suk-Ki KIM, Suwon-si (KR); Sang-Chul Han, Suwon-si (KR); Jung-Pil Park, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/710,548

(22) Filed: Feb. 23, 2010

(30) Foreign Application Priority Data
Jun. 30, 2009 (KR) 10-2009-0059284

(51) Int. Cl. G06F 3/038

(52) U.S. Cl. 345/213; 345/60

(57) ABSTRACT

A switching control circuit for a scan driving unit or a sustain driving unit of a plasma display panel driving device is disclosed. The switching control circuit includes a level shift circuit configured to generate a level-shifted signal by level shifting a control signal to a level referenced to a negative reference voltage, where the control signal was referenced to a ground voltage. The switching control circuit also includes a driver IC configured to amplify the level-shifted signal, and a switching circuit configured to perform a switching operation corresponding to the output signal.

### CROSS-REFERENCE TO RELATED APPLICATIONS

This application claims the benefit of Korean Patent Application No. 10-2009-0059284, filed on Jun. 30, 2009, in the Korean Intellectual Property Office, the disclosure of which is incorporated herein in its entirety by reference.

### BACKGROUND

1. Field

The field relates to a plasma display panel driving device, and more particularly, a plasma display panel driving device including a switching control circuit for switching a negative voltage.

2. Description of the Related Technology

In general, photocouplers are used when switching or controlling a negative voltage, for example, when a negative voltage is applied in a scan pulse or a sustain pulse in a plasma display panel. Photo couplers include a light emitting unit and a light receiving unit. The light emitting unit emits light and the emitted light is received by the light receiving unit, such that when the emitted light is received, a circuit connected to the light receiving unit is activated.

Photo couplers have a high-withstand voltage between voltages of input and output, and are resistant to noise because light is used as a signal delivery medium. In addition, since the light emitting unit and the light receiving unit are electrically insulated from each other, flow of current between the units is prevented and coupling of signals from the light receiving unit to the light emitting unit is prevented.

However, photo couplers are known to be relatively slow. Accordingly, Photo couplers are generally only suitable for a device that is able to be driven with low-speed switching operations, and are not suitable for a system that requires a high-speed switching operation or an accurate delay.

Additionally, i-couplers can be used instead of such photo couplers. However, i-couplers are expensive and thus have high manufacturing costs.

### SUMMARY OF CERTAIN INVENTIVE ASPECTS

One aspect is a plasma display panel driving device. The device includes a scan driving unit configured to apply a scan pulse and a first sustain pulse to a scan electrode, and a sustain driving unit configured to apply a second sustain pulse to a sustain electrode, where at least one of the scan driving unit and the sustain driving unit includes a switching control circuit. The switching control circuit includes a level shift circuit configured to level shift a control signal referenced to a ground voltage to a level referenced to a negative reference voltage to generate a level-shifted signal, and a driver IC configured to amplify the level-shifted signal, where the driver IC includes an input terminal for receiving the level-shifted signal, a ground terminal to which the negative reference voltage is applied, and an output terminal for outputting an output signal based on the level-shifted signal. The switching control circuit also includes a switching circuit configured to perform a switching operation corresponding to the output signal.

Another aspect is a switching control circuit for a scan driving unit or a sustain driving unit of a plasma display panel driving device. The switching control circuit includes a level shift circuit configured to level shift a control signal referenced to a ground voltage to a level referenced to a negative reference voltage to generate a level-shifted signal, a driver IC configured to amplify the level-shifted signal, where the driver IC includes an input terminal for receiving the level-shifted signal, a ground terminal to which the negative reference voltage is applied, and an output terminal for outputting an output signal based on the level-shifted signal. The switching control circuit also includes a switching circuit configured to perform a switching operation corresponding to the output signal.

Another aspect is a method of generating a signal for a plasma display panel driving device. The method includes level shifting a control signal referenced to a ground voltage to a level referenced to a negative reference voltage to generate a level-shifted signal, amplifying the level-shifted signal to generate an amplified signal, and performing a switching operation corresponding to the amplified signal to generate the signal for the plasma display panel driving device.

### BRIEF DESCRIPTION OF THE DRAWINGS

Various aspects will become apparent and more readily appreciated from the following description of the embodiments, taken in conjunction with the accompanying drawings of which:

FIG. 1 is a circuit diagram of a switching control circuit according to one embodiment;

FIG. 2 is a circuit diagram of a circuit for simulating the switching control circuit of FIG. 1;

FIG. 3 is a signal diagram illustrating signal waveforms measured at respective nodes of the switching control circuit of FIG. 2;

FIG. 4 is a block diagram of a plasma display panel driving device including a switching control circuit according to one embodiment; and

FIG. 5 is a signal diagram illustrating a driving waveform of the plasma display panel driving device of FIG. 4.

### DETAILED DESCRIPTION OF CERTAIN INVENTIVE EMBODIMENTS

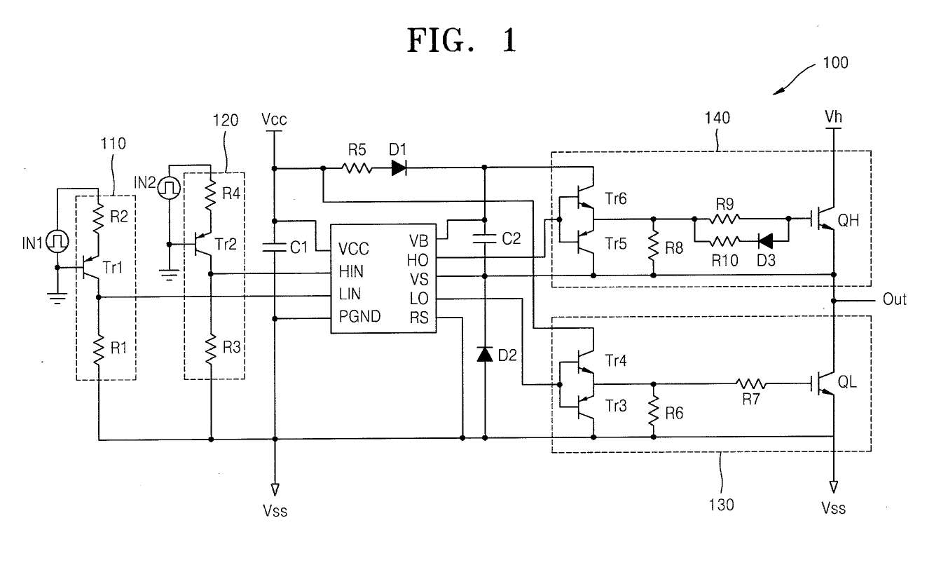

Hereinafter, embodiments will be described with reference to FIGS. 1-5.

FIG. 1 is a circuit diagram of a switching control circuit 100 according to an embodiment. The switching control circuit 100 includes a level shift circuit, a driver integrated circuit (IC), and a switching circuit.

The level shift circuit may include a first level shift circuit 110 and a second level shift circuit 120. The first level shift circuit 110 may include a transistor Tr1 and resistors R1 and R2, and the second level shift circuit 120 may include a transistor Tr2 and resistors R3 and R4.

The first level shift circuit 110 receives a control signal IN1 for switching a negative voltage as an input signal and shifts the level of the control signal IN1. The control signal IN1 may be a logic high or logic low signal with reference to a ground voltage, and the first level shift circuit 110 shifts the control signal IN1 to a level with reference to a reference voltage Vss. The reference voltage Vss may be a negative voltage. For example, the reference voltage Vss may be a voltage equal to or lower than about −5 V.

The first level shift circuit 110 may include the transistor Tr1 and the resistors R1 and R2. A first terminal of the transistor Tr1 is connected to a second terminal of the resistor R2 and the control signal IN1 is applied to the first terminal of the transistor Tr1, and a second terminal of the transistor Tr1 is grounded. In addition, a third terminal of the transistor Tr1 is connected to a first terminal of the resistor R1. The transistor Tr1 may be, for example, a bipolar junction transistor (BJT) for enabling high-speed switching. In regard to the transistor Tr1, the first terminal may be an emitter, the second terminal may be a base, and the third terminal may be a collector. In some embodiments, the transistor Tr1 is a PNP-type transistor.

The first terminal of the resistor R1 is connected to the third terminal of the transistor Tr1. The reference voltage Vss is applied to a second terminal of the resistor R1. In addition, the first terminal of the resistor R1 is connected to an LIN input terminal of the driver IC, which will be described later. Accordingly, the level-shifted control signal is applied as an input signal to the driver IC.

The control signal IN1 is applied to a first terminal of the resistor R2, and the second terminal of the resistor R2 is connected to the first terminal of the transistor Tr1.

The second level shift circuit 120 receives a control signal IN2 for switching a positive voltage as an input signal and shifts the level of the control signal IN2. The control signal IN2 may be a logic high or logic low signal with reference to a ground voltage, and the second level shift circuit 120 shifts the control signal IN2 to a level with reference to the reference voltage Vss. The reference voltage Vss may be a negative voltage. For example, the reference voltage Vss may be a voltage equal to or lower than about −5 V.

The second level shift circuit 120 may include the transistor Tr2 and the resistors R3 and R4. The connections between the transistor Tr2 and resistors R3 and R4 are similar to those described with reference to the first level shift circuit 110. The transistor Tr2 may be, for example, a BJT for enabling high-speed switching. In regard to the transistor Tr2, a first terminal may be an emitter, a second terminal may be a base, and a third terminal may be a collector. In some embodiments, the transistor Tr2 is a PNP-type transistor.

The driver IC receives a control signal and controls the switching circuit, which will be described later. The control signal may be a level-shifted signal. The driver IC may include input terminal HIN and the input terminal LIN, a ground terminal PGND, and output terminals HO and LO. In addition, the driver IC may further include a VCC terminal, a VB terminal, a VS terminal, and a RS terminal.

The input terminals LIN and HIN receive as an input signal the control signals IN1 and IN2 that have been respectively level-shifted by the first level shift circuit 110 and the second level shift circuit 120.

The reference voltage Vss is applied to the ground terminal PGND.

The output terminal LO outputs an output signal according to the input terminal LIN, and the output terminal HO outputs an output signal according to the input terminal HIN. The output signals are applied to the switching circuit, which will be described later.

A power source voltage Vcc is applied to the VCC terminal of the driver IC. In addition, the driver IC may further include a resistor R5, capacitors C1 and C2, and diodes D1 and D2 arranged between the terminals. However, the connection structure illustrated in FIG. 1 is for illustrative purposes only and is not limited thereto. For example, the connection relationship of the elements may vary, or other elements may be additionally used, according to the type of the driver IC or characteristics of the switching control circuit.

The switching circuit receives the output signals transmitted from the driver IC and performs a switching operation corresponding to the output signals. The switching circuit may include a first switching circuit 130 and a second switching circuit 140.

The first switching circuit 130 performs a switching operation corresponding to the output signal transmitted from the LO terminal of the driver IC. The first switching circuit 130 may include transistors Tr3 and Tr4, resistors R6 and R7, and a transistor QL. The transistor QL may be, for example, an insulated gate bipolar transistor IGBT. When the logic level of the output signal is high, the transistor QL is turned on to thus enable application of a desired voltage. The voltage may be the reference voltage Vss that is applied to the resistor R1 and the PGND terminal.

The second switching circuit 140 performs a switching operation corresponding to an output signal transmitted from the HO terminal of the driver IC. The second switching circuit 140 may include transistors Tr5 and Tr6, resistors R8, R9 and R10, and a transistor QH. The transistor QH may be an IGBT. When the logic level of the output signal is high, the transistor QH is turned on to thus enable application of a desired voltage. The desired voltage may be a positive voltage higher than the reference voltage. In addition, the desired voltage may be a positive voltage having about the same absolute value as that of the reference voltage Vss.

The transistors QL and QH are connected to a terminal connected to an output terminal and allow the voltage output by the switching operation to be output.

The connection relationships between the transistors and resistors illustrated in FIG. 1 are for illustrative purpose only and are not limited thereto.

The operation of the switching control circuit will now be described in detail.

When the control signal IN1 with reference to the ground voltage, that is, 0 V, is applied, current flows through the resistor R1 of the first level shift circuit 110. Due to the current flowing, a voltage drop corresponding to the value obtained by multiplying the resistance of R1 by the current occurs between the first and second terminals of the resistor R1. In this case, since the reference voltage Vss is applied to the second terminal of the resistor R1, the potential of the first terminal of the resistor R1 is represented by the following equation: the potential of the first terminal of the resistor R1=Vss+the resistance of R1×current. That is, the control signal IN1 is shifted to a level with reference to the reference voltage Vss.

The level-shifted control signal IN1 is applied to the LIN terminal of the driver IC.

The control signal IN2 is shifted to a level with reference to the reference voltage Vss in the same manner as described above and applied to the HIN terminal.

The driver IC receives the level-shifted control signals IN1 and IN2 and respectively outputs output signals to the HO and LO terminals, and the switching circuit operates according to the output signals.

As described above, by level-shifting applied control signal to a level with reference to a reference voltage that is a negative voltage, a high speed/high capacity driver IC may be used to switch a negative voltage.

In addition, according to an embodiment, the switching control circuit is formed by using just a few transistors instead of a photo coupler and thus the manufacturing costs are reduced.

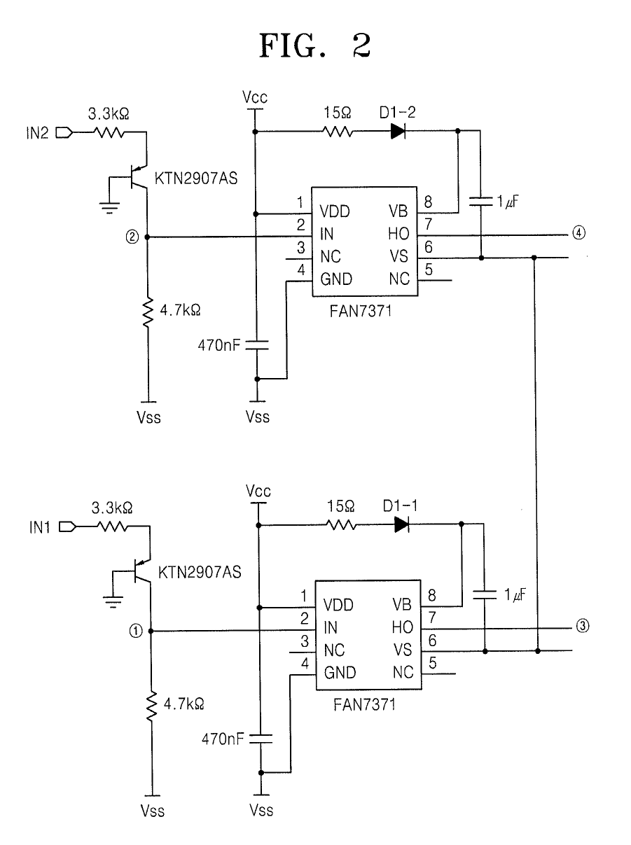

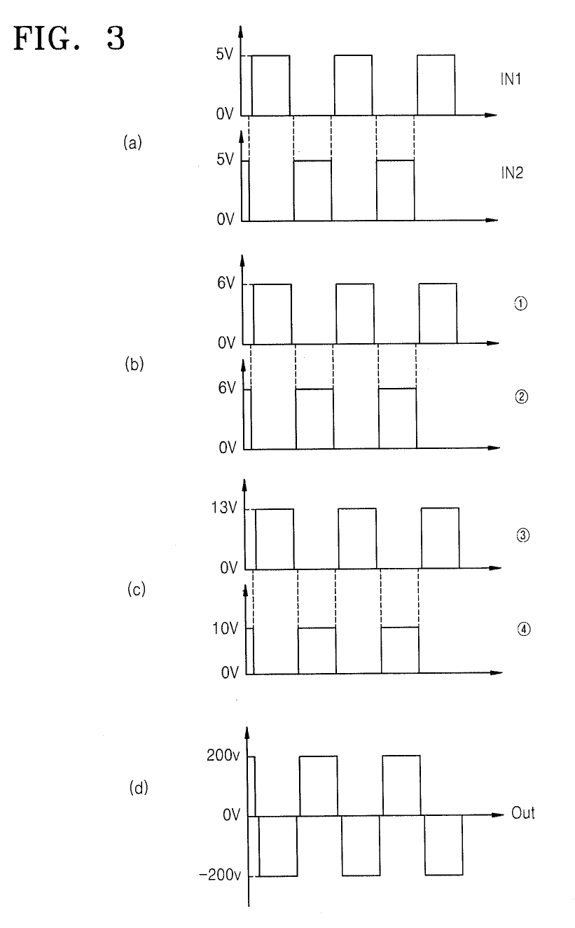

FIG. 2 is a circuit diagram of a circuit used for simulating the switching control circuit of FIG. 1, and FIG. 3 is a signal diagram illustrating signal waveforms (a) through (d) measured at respective nodes of the switching control circuit of FIG. 2.

Referring to FIG. 2, the switching control circuit is simulated using a FAN7371 (IC) as the driver IC and two KTN2907AS's as the transistors Tr1 and Tr2. The resistors R1 and R3 each have a resistance of 4.7 kΩ, and the resistors R2 and R4 each have a resistance of 3.3 kΩ. In addition, the capacitors each have a capacitance of 470 nF or 1 μF.

Waveforms of signals measured during the simulation performed with reference to FIG. 2 will be described. In FIG. 3, the values shown in graphs (b) and (c) represent the magnitude of a signal measured with reference to the reference voltage Vss. That is, in the graph (b) of FIG. 3, the actual value of 0 V is Vss, and the actual value of 6 V is Vss+6 V. In addition, in the graph (c) of FIG. 3, the actual value of 10 V is Vss+10 V, and the actual value of 13 V is Vss+13 V.

In FIG. 3, a graph (a) shows the waveforms of the control signals IN1 and IN2 respectively applied to the first switching circuit and second switching circuit. The control signals IN1 and IN2 have waveforms with reference to the ground voltage. For examples, the control signals IN1 and IN2 may be (transistor-transistor logic) TTL signals having voltages of 0 V or 5 V.

When the control signals IN1 and IN2 are respectively applied to the first switching circuit and the second switching circuit, the level-shifted waveforms of the graph (b) of FIG. 3 are respectively measured at a node \textcircled{1} and at a node \textcircled{2} of FIG. 2. If, in the graph (a), the magnitude of the control signal IN1 and IN2 are 5 V above the input ground, 6 V with above the reference voltage Vss is measured at the node \textcircled{1} and at the node \textcircled{2}.

The level-shifted waveforms are applied to the IN terminal of the driver IC, and the waveforms of the graph (c) of FIG. 3 are respectively measured at a node \textcircled{3} and at a node \textcircled{4} respectively connected to the HO output terminals of the Integrated Circuits.

The signals respectively measured at the node \textcircled{3} and at the node \textcircled{4} are applied to the switching circuit illustrated in FIG. 1, and a desired voltage is switched as in graph (d) of FIG. 3 by performing the switching operation of the switching circuit. This simulation is designed to switch 200 V and −200 V.

As described above, the driver IC may be used to switch a negative voltage by level shifting a control signal for switching of a negative voltage by using a level shift circuit.

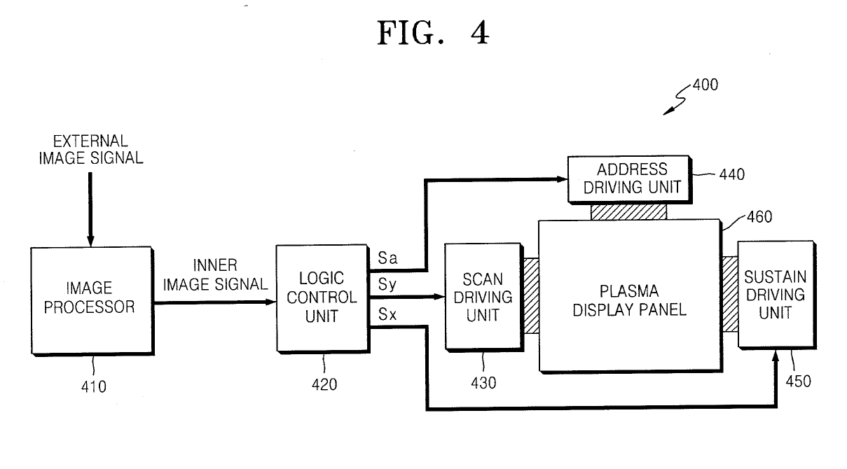

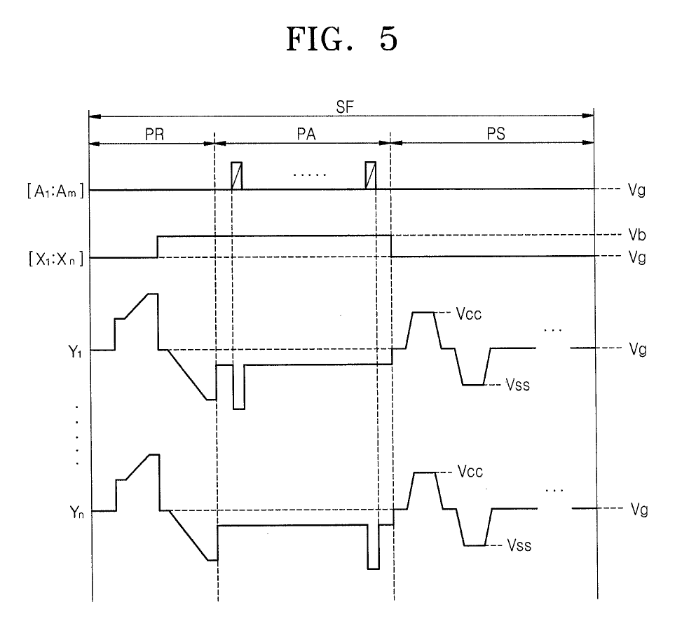

FIG. 4 is a block diagram of a plasma display panel driving device 400 including a switching control circuit according to one embodiment. FIG. 5 is a diagram illustrating a driving waveform of the plasma display panel driving device 400 of FIG. 4.

Referring to FIG. 4, the plasma display panel driving device 400 includes an image processor 410, a logic control unit 420, a scan driving unit 430, an address driving unit 440, a sustain driving unit 450, and a plasma display panel 460. The image processor 410 converts an external image signal received from the outside into an internal image signal. The logic control unit 420 receives the internal image signal and outputs an address driving control signal Sa, a scan driving control signal Sy, and a sustain driving control signal Sx.

The scan driving unit 430, the address driving unit 440, and the sustain driving unit 450 each receive a driving control signal and respectively output a scan pulse, an address pulse, and a sustain pulse to scan electrodes, address electrodes, and sustain electrodes of the plasma display panel 460.

The plasma display panel 460 includes the scan electrodes to which the scan pulse is applied, the address electrodes to which the address pulse is applied, and the sustain electrodes to which the scan pulse is applied. The plasma display panel 460 may have any structure that is known in the art.

The scan driving unit 430 and the sustain driving unit 450 may each include implementations of the switching control circuit of FIG. 1.

A driving operation of the plasma display panel 460 will be described with reference to FIG. 5.

Referring to FIG. 5, a single frame includes a plurality of subfields SF having different gray level weight values, and each of the subfields SF may be divided into a plurality of periods as illustrated in FIG. 5. Each of the subfields SF is divided into a reset period PR, an address period PA, and a sustain period PS.

The reset period PR is used for initializing a plurality of discharge cells. During the reset period PR, a reset signal including a positive pulse and a negative pulse is applied to scan electrodes Y1 through Yn. The positive and negative pulses may be applied as illustrated in FIG. 5. As shown, when application of the ascending pulse is finished, a bias voltage Vb that has a positive polarity is applied to sustain electrodes X1 through Xn that are disposed parallel to the scan electrodes Y1 through Yn. When the positive pulse is applied, weak discharge occurs in the discharge cells and wall charges begin to accumulate in the discharge cells. When the descending pulse and the bias voltage Vb are applied, weak discharge occurs in the discharge cells and the wall charges accumulated begin to be removed.

The address period PA is used for selecting discharge cells that are to be turned on. During the address period PA, a scan pulse is sequentially applied to the scan electrodes Y1 through Yn, and corresponding to the scan pulse, the address pulse is applied to address electrodes A1 through Am. The bias voltage Vb is continuously applied to the sustain electrodes X1 through Xn. By applying the scan pulse and the address pulse, a discharge cell that is to be turned on is selected. In the selected discharge cell, an address discharge occurs between the address electrode and the scan electrode.

The sustain period PS is used for sustain discharge a selected number of times corresponding to the allocated gray level weight value in the discharge cell that is selected to be turned on. The sustain pulse alternately has a high level Vh and a low level Vss and is alternately applied to the scan electrodes Y1 through Yn. By applying the sustain pulse, a sustain discharge is performed in the discharge cell that has been selected during the address period PA, in which the address discharge has been performed therein.

As described above, when the plasma display panel 460 is driven, the sustain pulse or the scan pulse may include a negative voltage for at least a part of the corresponding periods. To apply the negative voltage, the scan driving unit 430 and the sustain driving unit 450 may include a switching control circuit including the level shift circuit illustrated in FIG. 1 for switching a negative voltage. In addition, the same power source may be used for the low level voltage Vss of the sustain pulse of FIG. 5 and the reference voltage Vss used in the driver IC and/or the level shift circuit.

A plasma display panel and a driving device thereof have been described. However, the present invention is not limited thereto. For example, the present invention may be also applied to any flat panel display panel using switching of a negative power source.

As described above, in some embodiments, a high speed/high capacity driver IC is used in switching a negative voltage by level shifting a control signal referenced to a ground signal to a level referenced to a negative reference voltage. Such a switching control circuit may be applied in a flat panel display panel, such as a plasma display panel, requiring switching of a negative voltage.

In addition, a switching control circuit according to the embodiments can be formed by using just a few transistors instead of a photo coupler. Thus, the manufacturing costs may be reduced.

While certain embodiments have been described, it is to be understood that the invention is not limited to the disclosed embodiments, but, on the contrary, is intended to cover various modifications and equivalent arrangements.

What is claimed is:

1. A plasma display panel driving device, comprising:
a scan driving unit configured to apply a scan pulse and a first sustain pulse to a scan electrode; and
a sustain driving unit configured to apply a second sustain pulse to a sustain electrode,
wherein at least one of the scan driving unit and the sustain driving unit comprises a switching control circuit, the switching control circuit comprising:
a level shift circuit configured to level shift a control signal referenced to a ground voltage to a level referenced to a negative reference voltage to generate a level-shifted signal;
a driver IC configured to amplify the level-shifted signal, the driver IC comprising:
an input terminal for receiving the level-shifted signal;
a ground terminal to which the negative reference voltage is applied; and
an output terminal for outputting an output signal based on the level-shifted signal; and
a switching circuit configured to perform a switching operation corresponding to the output signal.

2. The plasma display panel driving device of claim 1, wherein the level shift circuit comprises:
a transistor comprising a first terminal to which a signal based on the control signal is applied, a second terminal that is grounded, and a third terminal connected to the input terminal of the driver IC; and
a resistor comprising a first terminal connected to the third terminal of the transistor and a second terminal to which the negative reference voltage is applied.

3. The plasma display panel driving device of claim 2, wherein the transistor is bipolar junction transistor (BJT).

4. The plasma display panel driving device of claim 2, wherein the level shift circuit comprises a second resistor comprising a first terminal to which the control signal is applied and a second terminal connected to the first terminal of the transistor.

5. The plasma display panel driving device of claim 1, wherein the negative reference voltage is equal to or less than −5 V.

6. The plasma display panel driving device of claim 1, wherein at least one of the first and second sustain pulses comprises a negative voltage for at least a part of a sustain period.

7. The plasma display panel driving device of claim 5, wherein the magnitude of the reference voltage is equal to the magnitude of the negative voltage of at least one of the first and second sustain pulses.

8. The plasma display panel driving device of claim 1, wherein the switching control circuit further comprises:
another level shift circuit configured to level shift a second control signal referenced to the ground voltage to a level referenced to the negative reference voltage to generate a second level-shifted signal,
wherein the driver IC is further configured to amplify the second level-shifted signal to generate a second output signal, and wherein the plasma display panel driving device further comprises a second switching circuit configured to perform a switching operation corresponding to the second output signal.

9. A switching control circuit for a scan driving unit or a sustain driving unit of a plasma display panel driving device, the switching control circuit comprising:
a level shift circuit configured to level shift a control signal referenced to a ground voltage to a level referenced to a negative reference voltage to generate a level-shifted signal;
a driver IC configured to amplify the level-shifted signal, the driver IC comprising:
an input terminal for receiving the level-shifted signal;
a ground terminal to which the negative reference voltage is applied; and
an output terminal for outputting an output signal based on the level-shifted signal; and
a switching circuit configured to perform a switching operation corresponding to the output signal.

10. The switching control circuit of claim 9, wherein the level shift circuit comprises:
a transistor comprising a first terminal to which a signal based on the control signal is applied, a second terminal that is grounded, and a third terminal connected to the input terminal of the driver IC; and
a resistor comprising a first terminal connected to the third terminal of the transistor and a second terminal to which the negative reference voltage is applied.

11. The switching control circuit of claim 10, wherein the transistor is bipolar junction transistor (BJT).

12. The switching control circuit of claim 10, wherein the level shift circuit comprises a second resistor comprising a first terminal to which the control signal is applied and a second terminal connected to the first terminal of the transistor.

13. The switching control circuit of claim 9, wherein the negative reference voltage is equal to or less than −5 V.

14. The switching control circuit of claim 9, further comprising:
another level shift circuit configured to level shift a second control signal referenced to the ground voltage to a level referenced to the negative reference voltage to generate a second level-shifted signal,
wherein the driver IC is further configured to amplify the second level-shifted signal to generate a second output signal, and wherein the plasma display panel driving device further comprises a second switching circuit configured to perform a switching operation corresponding to the second output signal.

15. A method of generating a signal for a plasma display panel driving device, the method comprising:
level shifting a control signal referenced to a ground voltage to a level referenced to a negative reference voltage to generate a level-shifted signal;
amplifying the level-shifted signal to generate an amplified signal; and
performing a switching operation corresponding to the amplified signal to generate the signal for the plasma display panel driving device.

16. The method of claim 15, wherein level shifting the control signal comprises providing current to a resistor connected to the negative reference voltage, wherein the current is based on the control signal.

17. The method of claim 16, wherein substantially no current is provided to the resistor when the control voltage is substantially equal to the ground voltage.

18. The method of claim 16, wherein the current provided to the resistor is substantially equal to the control voltage divided by the sum of the resistance of the resistor and the resistance of a second resistor.

19. The method of claim 15, wherein the negative reference voltage is equal to or less than −5 V.

20. The method of claim 15, further comprising:
level shifting a second control signal referenced to the ground voltage to a level referenced to the negative reference voltage to generate a second level-shifted signal;
amplifying the second level-shifted signal to generate a second output signal; and
performing a switching operation corresponding to the second output signal to generate the signal for the plasma display panel driving device.
